(19) United States
(12) Patent Application Publication
(10) Pub. No.: US 2014/0255790 A1
(43) Pub. Date: Sep. 11, 2014

(54) POLYMERIC POROUS SUBSTRATES INCLUDING POROUS PARTICLES

(71) Applicant: DOW GLOBAL TECHNOLOGIES LLC, Midland, MI (US)

(72) Inventors: Scott Matteucci, Midland, MI (US); Brian Nickless, Bay City, MI (US); Beata Kilos, Midland, MI (US); Hao Ju, Minnetonka, MN (US)

(73) Assignee: DOW GLOBAL TECHNOLOGIES LLC, Midland, MI (US)

(21) Appl. No.: 14/350,942

(22) PCT Filed: Nov. 9, 2012
(86) PCT No.: PCT/US2012/064354

§ 371 Date: Apr. 10, 2014

Related U.S. Application Data
(60) Provisional application No. 61/558,314, filed on Nov. 10, 2011.

(51) Int. Cl. H01M 2/16

(52) U.S. Cl. CPC H01M 2/166; H01M 2220/20
USPC 429/252

(57) ABSTRACT

A polymeric porous substrate is described. The substrate may be used as battery separator or in other industrial applications. The polymeric porous substrate is formed from a polymer such as a polyimide or polyetherimide that, in the absence of porous particles, forms a skin when cast into a substrate. The polymeric porous substrate also includes porous particles.

### TECHNICAL FIELD

The present disclosure relates to polymeric porous substrates including porous particles. Such polymeric porous substrates with porous particles may be used, for example, as battery separators and in other industrial applications.

### BACKGROUND

Efforts to migrate away from dependence on oil and other fossil fuels have led many industries to spend research and development capital to develop environmentally-friendly or “green” technologies. Such green technologies include improved batteries that can be used in, for example, the automotive industry. Indeed, the United States Advanced Battery Consortium (USABC) was formed to develop electrochemical energy storage technologies which support commercialization of fuel cell, hybrid, and electric vehicles. This includes batteries and battery components.

Batteries and battery components for automotive applications must be sufficiently robust to endure operating conditions. For example, battery separators must have high heat and electrolyte resistance, low shrinkage during use, and must permit sufficient flow of ions for the battery to be operational. The USABC has published specification goals for battery separators suitable for lithium ion batteries usable in an automotive environment.

Prior attempts to develop battery separators for modern and future automotive batteries have been undertaken using polymers and polymer blends that tended to exhibit satisfactory heat and electrolyte resistance, but the polymers and polymer blends formed a dense polymer skin at the surface. Such potential battery separator materials included, for example, polyimides such as polyetherimide (PEI). Unfortunately, the dense skin acted as a barrier to ion flow between the anode and the cathode, rendering the resultant material inadequate for use as a battery separator. Indeed, Gurley flow for such materials, which is used as a proxy for ion flow, has been over 10,000 s/100 cc and as high as 27,000 s/100 cc. A much lower Gurley flow is required for a material to be used as a battery separator.

### SUMMARY

Polymeric porous substrates have been discovered that solve at least some of the challenges left unsolved by prior research in battery technologies. Such polymeric porous substrates may have other uses and applications as well. Such polymeric porous substrates include at least one polymer that, when formed into a substrate in the absence of porous particles, generates a skin in the substrate. The skin may be thick and/or dense such that the skin renders the resultant substrate substantially impermeable to ion flow. “Substantially impermeable” means that incidental ion flow may exist between an anode and cathode, but not enough for the substrate to function as a battery separator. The polymeric porous substrates disclosed herein include a plurality of porous particles together with the at least one polymer. By including porous particles with the at least one polymer when the polymeric porous substrate is formed, the resultant polymeric porous substrate permits sufficient ion flow between an anode and a cathode for the resultant polymeric porous substrate to function as, among other uses, a battery separator.

### BRIEF DESCRIPTION OF THE DRAWINGS

Referring now to the drawings, illustrative embodiments are shown in detail.

FIG. 1 depicts a plot of Gurley flow for an exemplary polymeric porous substrate against the porous particle concentration in the separator by volume;

FIG. 2 depicts a plot of Gurley flow for an exemplary polymeric porous substrate against the porous particle concentration in the separator by volume for different porous particles;

FIG. 3 depicts a schematic of a battery containing an exemplary battery separator; and

FIG. 4 depicts an automobile with batteries of the type described in FIG. 3.

### DETAILED DESCRIPTION

This disclosure relates generally to polymeric porous substrates formed from polymers that ordinarily form thick or dense skins, rendering the substrate substantially unusable as a battery separator. The battery separators disclosed herein are manufactured by forming a porous substrate using such polymers together with porous particles. Without being bound by theory, it is believed that during the substrate forming process, many such porous particles migrate to the locations where the substantially ion-impermeable skin would be in the absence of the porous particles. The pores in the particles permit ion flow through the porous substrate between an anode and a cathode, thereby unexpectedly rendering polymers previously considered unusable due to processing issues as a battery separator material usable as a material in a battery separator.

### Polymers

A wide range of polymers may be used to form the polymeric porous substrates. In particular, polymers that are capable of forming a substrate via a phase inversion separation process may be useful. Such polymers are soluble in a first solvent or a mixture of solvents, insoluble in a second solvent (non-solvent), where the first and second solvents are miscible. Additionally, polymers that form thick and/or dense skins when forming a substrate may be useful in connection with the battery separators disclosed herein. Illustrative, non-limiting polymers may include polyketones, polyvinyl chlorides, and polysulfones.

Non-limiting exemplary polymers that may be used with the polymeric porous substrates disclosed herein include polyimides such as polyetherimides (PEI). PEI is an amorphous thermoplastic polymer having a repeating unit with the following structure:

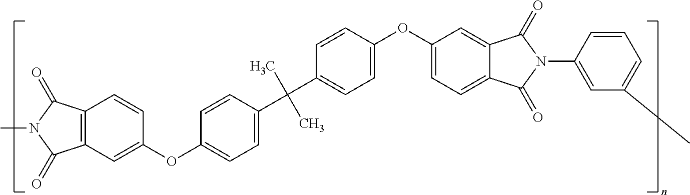

A wide range of PEIs may be used in connection with the polymeric porous substrate disclosed herein. Commercially available sources of PEI and PEI-based resins are available under the ULTEM trademark, owned by Sabic Innovative Plastics of Pittsfield, MA. Other PEIs include unmodified PEI, substituted PEI, and the aromatic polyetherimides of the type disclosed in U.S. Pat. No. 4,612,353, assigned to The Dow Chemical Co.

Generally, PEI and PEI-blends have high heat resistance, high strength and modulus, excellent electrical properties and excellent processibility. The thermal properties of PEIs contemplated for use with the battery separators disclosed herein may include a deflection temperature of 190° C. to 220° C., a thermal expansion coefficient of from 1.0×10⁻⁵ to 3.5×10⁻⁵ in/in-° F., a glass transition temperature of from 200° C. to 250° C., or from 210° C. to 235° C., or 216° C., a thermal conductivity of from 0.7 to 2.0 BTU-in/hr-ft²-° F., and a flammability of V-0 using UL94.

The electrical properties of PEIs contemplated for use with the battery separators disclosed herein may include a dielectric strength in air of from 700 to 900 V/mil, a dielectric constant of from 3 to 4, a dissipation factor of from 0.001 to 0.003, and a volume resistivity of from 1.0×10¹⁶ to 1.0×10¹⁸ ohm-cm.

The mechanical properties of PEIs contemplated for use with the battery separators disclosed herein may include a tensile strength break at 23° C. of from 14,000 psi to 25,000 psi and a tensile modulus at 23° C. of from 400,000 psi to 2,000,000 psi, an elongation at break at 23° C. of from 30% to 70%, an elongation at yield at 23° C. of from 4% to 10%, a flexural strength at 23° C. of from 18,000 psi to 40,000 psi, and a flexural modulus at 23° C. of from 0.7 to 2.0 ft-lbs/in.

Contemplated polymers and polymer blends and combinations of same may resist a broad range of chemicals under varied conditions of stress and temperatures. Such polymers may be compatible with aliphatic hydrocarbons and alcohols, mineral-salt solutions, dilute bases, and fully halogenated hydrocarbons.

The polymeric porous substrates disclosed herein may include from 40% to 99.9% by volume of polymer, or from 45% to 80% by volume of polymer, or from 50% to 70% by volume of polymer. Although these volume percentages are described as nested, any of the lower limits is contemplated for use in a range with any of the upper limits of the specified ranges.

### Porous Particles

A wide range of porous particles may be used in connection with the polymeric porous substrates disclosed herein. Porous particles may include silica, alumina, aluminosilicate materials, zeolites, aerogels, organic or inorganic porous powders, or combinations including one or more of same. Porous particles may be coated or uncoated, the particles may have an organic surface treatment, that in certain cases is chemically bound to the particle. Exemplary commercially available aerogels including porous particles include CABOT NANOGEL, since rebranded to CABOT ENOVA, from CABOT Corporation, which also may be suitable for use with the polymeric porous substrates and battery separators disclosed herein. Exemplary porous particles and methods for making same are described in U.S. Pat. Nos. 6,506,485, 6,592,764, 6,641,657, 6,746,659, 6,843,977, 6,869,906, 7,014,799, 7,123,892 and 7,167,245.

Porous particles may have an average particle size of diameter of less than 10 microns, less than 1 micron, or less than 100 nm. The average particle size selected should be sufficiently small to avoid damaging substrate formation with agglomerated particles.

Pore size of the porous particles may be microporous, mesoporous, or macroporous, and may include a combination of one or or more types of particles with different pore sizes. Microporous particles have pores that are up to 2 nm, whereas mesoporous particles have pores that are 2 to 50 nm, and macroporous particles have pores larger than 50 nm.

Exemplary porous particles may include mesoporous cellular foam (MCF) particles. Suitable MCF particles may be synthesized as exemplified herein, as described in one or more of the patents identified above, or purchased from commercially available sources. Additional syntheses of suitable MCF particles are described in, at least, Kipemboi, Kikprono et al., Preparation of mesoporous silica with amphilic poly(oxyethylene)/poly (oxybutylene) diblock and poly (oxyethylene)/poly (oxypropylene) triblock copolymers as templates Indian J. Chem. 2009, 48A pp. 498-503 and Lettow, Han et al., Hexagonal to Microcellular Foam Phase Transition in Polymer-Templated Mesoporous Silicas Langmuir 2000 16 pp. 8291-8295.

The polymeric porous substrates disclosed herein may include from 0.1% to 60% by volume of porous particles, or from 20% to 55% by volume of porous particles, or from 30% to 50% by volume of porous particles. Although these volume percentages are described as nested, any of the lower limits is contemplated for use in a range with any of the upper limits of the specified ranges.

### Optional Ingredients

The polymeric porous substrates disclosed herein may include any number of optional additives such as wetting agents, plasticizers, thickeners, binders, and additional fillers. When the polymeric porous substrate is to be used as a battery separator, the optional ingredients should be substantially inert with respect to the electrolyte of the battery, such as silicon oxide, silica gels, polysilicates, diatomaceous earths, minerals, clays, calcium carbonate and wood flour. The polymeric porous substrates may also include additional polymers, regardless of whether such polymers form a dense and/or thick skin on their surface when cast into a substrate.

### Thin Polymeric Porous Substrate Formation

The polymer(s) and porous particle ingredients, plus any optional ingredients, may be processed to form a porous substrate using a wide range of commercial methods. By way of non-limiting example, the polymeric porous substrate may be formed by a phase inversion process. The polymeric porous substrate may have a thickness ranging from 1 to 500 microns, 10 to 100 microns, or 10 to 50 microns. Although these thicknesses are described as nested, any of the lower limits is contemplated for use in a range with any of the upper limits of the specified ranges.

### Exemplary Polymeric Porous Substrate Properties

Without being bound by theory, the addition of porous particles to polymeric resins appears to give the polymer a performance indicative of a porous surface (i.e., the skin at the surface of the porous substrate has been broken) that unexpectedly improves (that is, reduces) Gurley flow, which is an indicator that the resultant polymeric porous substrate is functional as a battery separator. This may result from the physical location in the substrate where porous particles tend to migrate during a substrate forming process. In any event, surprisingly, the Gurley flow of the polymeric substrate with porous particles reflects that ion transport is sufficient for a battery separator, even for polymeric resins including polymers such as PEI that are ordinarily expected to be unusable as a battery separator. Additionally, the other mechanical, electrical and thermal properties of polymeric resins remain sufficient in the substrate for use as a battery separator even though the polymeric substrate has been modified by the addition of porous particles.

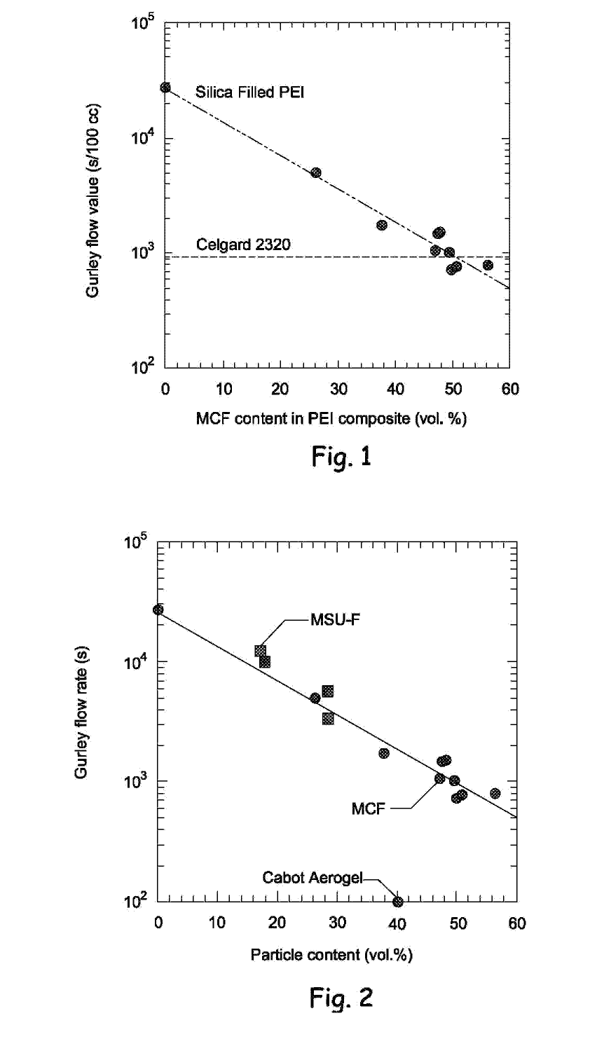

Turning to FIG. 1, an exemplary formulation is shown. The exemplary formulation is a PEI substrate that includes porous silica. The higher the volume percentage of the porous silica particles in PEI, the better (the lower) the Gurley flow. The trend appears roughly linear, as shown. The exemplary formulation is compared to CELGARD 2320, which comprises ultra-high molecular weight polyethylene. Unexpectedly, at 46% by volume of porous silica particle content, the exemplary formulations had substantially the same Gurley flow as the CELGARD product. All of the data reflecting MCF particle content reflected a Gurley flow of less than 1500 s/100 cc gas, and when the MCF particle content reached 35% by volume, the Gurley flow data points were all less than 1100 s/100 cc gas.

Because of its constituent materials, CELGARD 2320 may have shrinkage challenges during battery fabrication and/or during battery operation during high intensity applications such as automotive applications. Certain polymers such as UDEL polysulfones, RADEL polyethersulfones, PEI and PEI-polycarbonate blends are understood to resist shrinkage well. It has been discovered that polymeric porous substrates of such heat and shrink resistant polymers containing porous particles perform similarly to those polymers regarding shrinkage in the absence of the porous particles. That is, the addition of porous particles did not negatively impact shrinkage performance. Table 1 demonstrates shrinkage data for PEI.

TABLE 1
Thermal Shrinkage

| | Thermal Shrinkage | | | |
|---|---|---|---|---|
| | 100° C., | 150° C., | 200° C., | 220° C., |
| Substrate | 1 h | 1 h | 1 h | 1 h |
| PEI | No change | No change | <2% | <2% |
| PEI/MCF with a | No change | No change | <2% | <2% |
| weight ratio in | | | | |
| casting solution | | | | |
| of 100/7 PEI to | | | | |
| MCF particles | | | | |
| PEI/MCF with a | No change | No change | <2% | <2% |
| weight ratio in | | | | |
| casting solution | | | | |
| of 100/10 PEI to | | | | |
| MCF particles | | | | |

Turning to FIG. 2, exemplary formulations are shown wherein Gurley flow of PEI is reduced by the addition of MSU-F, a commercially available mesoporous silica foam sold by Sigma Aldrich, silica referred to as MCF on FIG. 2, and CABOT NANOGEL. All demonstrate an unexpectedly low Gurley flow for a PEI-containing substrate.

Additionally, for polymeric porous substrates to be used as battery separators, it may be desirable to have certain additional physical, thermal and electrical properties. For example, battery separators disclosed herein should have properties giving them utility in a lithium ion battery to be used in an automotive environment.

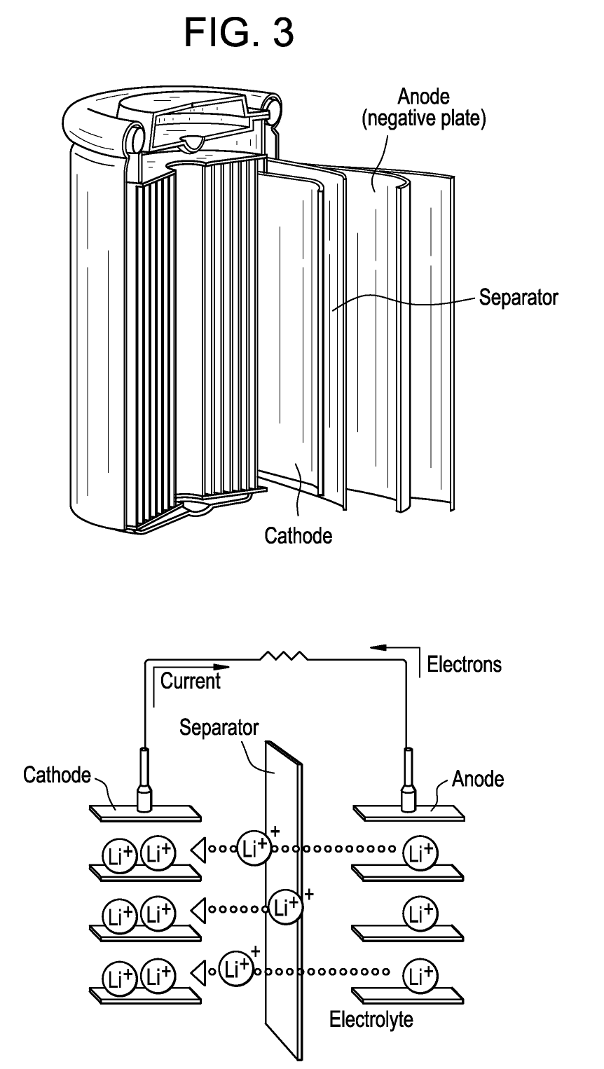

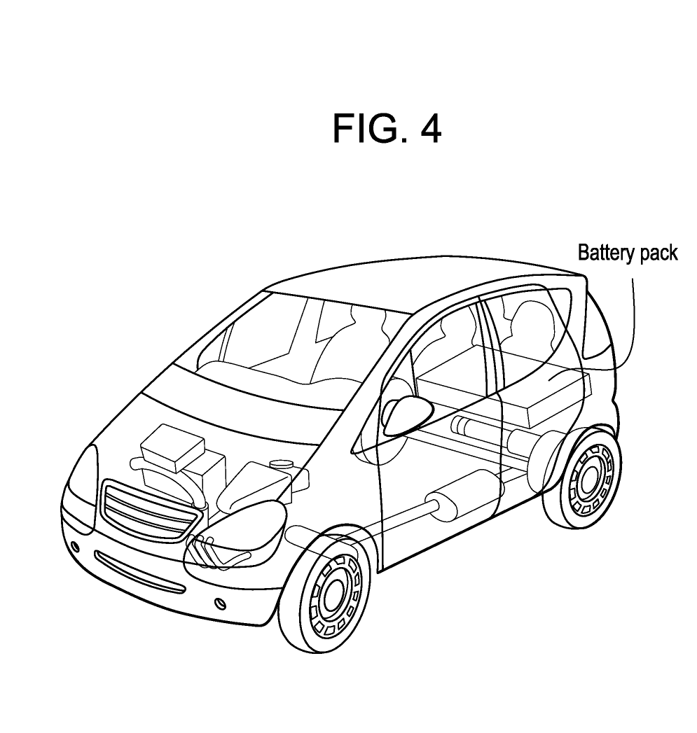

Turning to FIG. 3, a sample schematic for a lithium ion battery is depicted. A separator is shown sandwiched between an anode and a cathode in a configuration. The separator allows transport of lithium ions therethrough. In the depiction, lithium ions travel from the anode through the electrolyte and through the separator into the electrolyte of the cathode. Electrons travel from the anode to the cathode, and current flows in the opposite direction. FIG. 4 depicts a battery pack containing a plurality of batteries of the type depicted in FIG. 3 installed in an automobile.

The USABC has set forth target specifications for battery separators in lithium ion batteries that are usable in, at least, an automotive environment. The USABC target specifications for the disclosed battery separator in a lithium ion battery and associated test methodologies for determining whether the specifications have been met are set forth below. It should be noted that the lithium ion battery environment is described for exemplary purposes and does not limit the scope of the appended claims.

Exemplary battery separators may be substantially free of defects such as pinholes, gels, wrinkles, contaminants, etc. Manufacturing procedures and quality controls may be used to minimize these and other defects.

The target thickness of an exemplary battery separator for a lithium battery may be less than 25 microns, or between 20 and 25 microns, or from 0.8 mil to 1 mil, as determined by ASTM Test Method D5947-96 or ASTM D2103.

The target permeability of an exemplary battery separator may be substantially uniform. The permeability may have a MacMullin Number of less than or equal to 11, or less than or equal to 8. A MacMullin Number is the ratio of the resistivity of the separator filled with the electrolyte divided by the resistivity of the electrolyte alone. The MacMullin Number may be measured as explained in U.S. Pat. No. 4,464,238, titled “Porous separators for electrolytic processes,” and assigned to The Dow Chemical Co. For hybrid electric vehicle (HEV) cells, the MacMullin number should be as low as possible. Regarding measuring a MacMullin Number, it should be understood that the presence of a battery separator can increase the effective resistivity of an electrolyte by as much as a factor of four or five. Because electrical resistivity can be difficult to measure, one of skill in the art may use air permeability measurements, which are proportional to electrical conductivity for a given separator morphology. In this way, once the separator morphology is fixed or substantially fixed, air permeability may be measured according to ASTM D726 to monitor the permeability of the battery separator.

The target pore size of pores in an exemplary battery separator may be less than 1 micron, as measured by ASTM Test Method E128-99. Pores that are too large may allow transfer of particles between the anode electrode and the cathode electrode that should be blocked. Such particles are often substantially larger than 1 micron. The pores should also minimize or substantially prevent the passage of conductivity aids such as carbon black. Carbon black particles can have particle sizes as small as 10 nm, but these particles tend to form agglomerates that are larger than 1 micron. Thus, the pore size should be selected to block common agglomerate, understanding that individual carbon black particles may pass through.

The wettability of an exemplary battery separator may be such that a complete or substantially complete wet-out would occur with typical battery electrolytes. One way to test is to place a drop of electrolyte on the separator and observe whether the droplet quickly wicks into the separator. A typical but non-limiting electrolyte may be a 1:1 volume ratio of ethylene carbonate to dimethyl carbonate containing 1 M LiPF₆.

The chemical stability of an exemplary battery separator may be such that the battery separator would remain stable or substantially stable in a battery for about ten years. This stability reflects the ability to withstand extreme oxidation environments (including, for example, manganese dioxide, nickel dioxide, or cobalt dioxide) and extreme reduction environments (including, for example, lithiated carbon). A stable separator does not substantially degrade or lose substantial mechanical strength or produce substantial impurities. Substantial, in this context, means sufficient to interfere with the function of the battery.

The thermal stability of an exemplary battery separator may be such that the battery separator would experience less than 5% by volume shrinkage after 60 minutes at 90° C. This may be determined by ASTM D1204. Battery separators should have sufficient thermal stability to withstand drying procedures and the like used in manufacturing without substantial shrinking (more than 5%). For example, lithium ion batters may be dried at 80° C. under vacuum.

The puncture strength of an exemplary battery separator may be greater than 300 g/25.4 microns, as may be determined by ASTM F1306-90. Puncture strength is the weight that must be applied to a needle to force it completely through a separator. There is some evidence that puncture strength correlates to the ability of a battery separator to prevent penetration of particulate material through the separator. Such penetration may cause an electrical short.

The water content of an exemplary battery separator may be less than 50 ppm, as may be determined by Karl Fischer titration using a device equipped with a drying oven. From 2 to 3 grams of the separator material may be weighed and placed into a sample boat, which may in turn be heated to 200° C. with an air stream flow rate of 100 mL/min for analysis.

The melt integrity of an exemplary battery separator may be greater than or equal to 200° C., as may be determined by a thermo-mechanical analysis (TMA). Integrity is lost at the temperature which the battery separator loses physical integrity; that is, viscosity is sufficiently low to permit contact between battery electrodes. This temperature may be determined by measuring the elongation of a separator under load (such as 5 g/cm) as a function of temperature. In such a test, the TMA output includes elongation versus temperature data.

An exemplary battery separator should provide a margin of protection against short circuit and overcharge. As mechanical integrity of the battery separator increases, the margin of safety also increases. If mechanical integrity is lost and the electrodes come into contact, thermal runaway may occur. Instituting a sufficiently low shutdown temperature can prevent thermal runaway. Shutdown temperatures will depend upon the material(s) from which the separator is formed. A shutdown temperature, as may be measured by a hot ER test, may be 100° C. +/−10° C. For example, ultrahigh molecular weight polyethylene can exhibit mechanical integrity to 180° C., so a shutdown temperature can be selected at a temperature sufficiently lower than 180° C.

An exemplary battery separator may be included in a spirally wound lithium ion cell. If so, the USABC sets forth additional goals for the separator. For example, the tensile strength should not elongate significantly under tension. In one embodiment, there is less than 2% offset under 1000 psi. The degree of elongation may be tested according to ASTM Test Method D882-00.

An exemplary battery separator should be substantially free of bowing or skewing. An exemplary battery separator may, however, have a limited skew, or misalignment between the electrodes and the battery separator. Such a limited skew, for example, may be less than 2 mm/m. Skew may be measured by laying a separator flat on a table parallel with a straight meter stick.

### EXAMPLES

### Example 1

### Synthesis of an Exemplary Polymeric Blend

ULTEM-1000 polyetherimide and ULTEM-CRS5011 enhanced polyetherimide copolymer were pre-mixed using a Thermo Haake Polylab mixing system with a Rheomix 3000p bowl. The resins were combined in a ratio of 80:20 (ULTE -1000/ULTEM-CRS5011, w/w), and were placed into the Haake mixer, the temperature of which was maintained at 250° C. The mixture was blended for 15 minutes at a rotational speed of 200 rpm. The mixed resin was then cut to small pieces using a manual polymer cutter, ground to 20 mesh, and then the PEI pellets were dried at 150° C. under vacuum overnight before using the pellets.

### Example 2

### Synthesis of Exemplary Porous Particles

Porous particles were prepared as described in the open literature by Schmidt-Winkel et al. Mesocellular siliceous foams with uniformly sized cells and windows Journal of American Chemistry Society, 1999, 121, p. 254-255, as well as U.S. Pat. Nos. 6,506,485, 6,641,647, and 6,592,764. In this instance, 10g of PEO-PPO-PEO triblock copolymer (PLURONIC P123, EO₂₀-PO₇₀-EO₂₀, molecular weight ˜5800, BASF) were placed in 375 ml of 1.6 M HC1 at room temperature. To the polymer solution was slowly added 15 g of 1,3,5-trimethylbenzene and then the mixture was heated to 40° C. After 60 min 22 g of tetraethyl orthosilicate was added. After 20-24 hours at 40° C. milky solution was transferred to an autoclave and aged at 100° C. for the next 24 hours. Solid product was filtered and washed with DI water. After drying at room temperature for 24 hours the surfactant was removed by calcination at 550° C. for 8 hours in air flow to generate MCF silica particles.

### Example 3

### Synthesis of a Thin Polymeric Porous Substrate

PEI substrates were formed via a phase-inversion process. Polymer solutions, containing solvent NMP, 26 wt. % PEI based on NMP (i.e., 0.26 g PEI/(g PEI+NMP)), and porous silica, were used for casting. Silica content was varied from 0 to 20 wt. % relative to PEI (i.e., g silica/g PEI). Generally, appropriate amounts of PEI, NMP, and porous silica were added into a tared 10 ml dram vial, and the vial was then placed into a 215° C. convection oven. The vial was shaken vigorously every 20 minutes to ensure complete PEI dissolution and uniform silica dispersion. The casting solution was allowed to cool down to around 90° C. before casting.

A glass plate was cleaned with acetone to remove any dust on the surface and dried in air before casting. The solution was removed from the oven and cooled in air for 5 minutes. The cooled solution was spread on the cleaned glass plate using a bird applicator at a constant drawing speed of 6 to 8 feet per minute, followed by an immediate quenching into an ethanol bath. Consequently, a solid porous silica filled PEI substrate was obtained, the thickness of which was controlled by choosing a proper bird applicator. The PEI substrate was readily peeled off the glass substrate and soaked in ethanol overnight. To obtain the dry substrate, the soaked PEI substrate was kept in air for 12 hours.

The exemplary thin porous polymeric substrates were analyzed as described below.

### Silica Content in Polymeric

The content of porous silica in the PEI substrates was determined using thermogravimetric analysis (TGA). The equipment included a TGA Q-5000 from TA Instruments (New Castle, DE). A PEI sample having a total weight of 5 to 10 mg was placed in an aluminum pan and heated to 700° C. in air at a heating rate of 5° C./min. The sample weight before PEI decomposing (Wₜ) and after PEI decomposing (Wₛₜ) were determined from TGA thermograms, and the silica content was calculated as follows:

$$ω = \frac{{W}_{si}}{{W}_{t}} \cdot 100 \% \qquad Equation 1$$

By assuming ideal mixing behavior of silica and PEI, the volume content of silica in PEI substrates, v, was estimated as follows:

$$υ = \frac{\frac{{W}_{si}}{{ρ}_{si}}}{\frac{{W}_{t} - {W}_{si}}{{ρ}_{PEI}} + \frac{{W}_{si}}{{ρ}_{si}}} \cdot 100 \% \qquad Equation 2$$

where ρ_{PEI} is the density of PEI (1.24 g/cm³) and ρₛᵢ is the density of porous silica (0.2 g/cm³ for synthesized particles and 0.254 g/cm³ for MSU-F).

The silica content for the substrates of Example 3 is tabulated in Table 2. Each sample loses approximately 4 wt % as temperature increases from 100° C. to 200° C., possibly due to the loss of water initially absorbed. PEI polymer decomposes starting at 450° C. and completes decomposition before 700° C. The weight of the silica particles is retained as a residue at 700° C.

### Gurley Flow

A Genuine Gurley Instruments densometer was used for measuring Gurley flow values of the PEI substrates cast as part of Example 3. The densometer records the time required for a given volume of air (e.g., 100 cc used in this study) to flow through substrates with a standard area under light uniform pressure. The testing procedure conforms to ASTM D 726-58. Measurements were taken at four different locations on the PEI substrate surface to determine the average Gurley flow value and the standard deviation in the Gurley flow values.

Gurley flow values of PEI substrates were measured and the values are recorded in Table 2. As Table 2 shows, the silica-filled PEI samples exhibit lower Gurley flow values (i.e., higher air permeability) than that of the pure PEI control, which may result from their porous surface structures. Additionally, uniform permeability in separators is also desired for batteries to have a long, reliable cycle life. To evaluate uniformity in permeability, Gurley flow through different locations on a sample were tested, and the values are recorded in Table 3. As shown in Table 3, PEI/MCF (100/15) substrates exhibit high uniformity with having essentially the same Gurley flow value at various locations. However, as the MCF content increases from 15 wt % to 20 wt % (MCF/PEI), the deviation in Gurley flow values becomes larger. The larger deviation suggests inconsistent structures. These results indicate that increasing MCF content in PEI substrates far beyond 30% by weight may reduce the uniformity of permeability in a battery separator.

TABLE 2
Properties of Exemplary Polymeric Porous Substrates

| | Silica | Silica | | |
|---|---|---|---|---|
| | Content | Content | Thickness | Gurley Flow |
| Sample | (wt. %) | (vol. %) | (μm) | (s/100 cc) |
| PEI | 0 | 0 | 20.8 | 26,849 |
| PEI/MCF (100/7)* | 5.25 | 26.2 | 42.5 | 5,000 |
| PEI/MCF (100/10) | 8.67 | 37.8 | 32.0 | 1,741 |
| PEI/MCF (100/15)¹ | 12.4 | 47.5 | 39.2 | 1,466 |
| PEI/MCF (100/15)² | 12.2 | 47.1 | 29.0 | 1,059 |
| PEI/MCF (100/20)¹ | 16.7 | 56.3 | 41.5 | 786 |
| PEI/MCF (100/20)² | 13.5 | 49.9 | 34.5 | 723 |
| PEI/MCF (100/15)¹ | 12.6 | 47.9 | 48.0 | 1,058 |
| PEI/MCF (100/15)² | 13.3 | 49.5 | 46.0 | 1,013 |
| PEI/MCF (100/20)¹ | 13.8 | 50.7 | 43.0 | 775 |
| PEI/MCF (100/20)² | 15.9 | 54.8 | 42.4 | n/a |

*100/7 is the weight ratio of PEI to MCF in casting solutions
¹prepared from 1^{st} half of the polymer solution
²prepared from 2^{nd} half of the polymer solution

TABLE 3
Gurley Flow Values Measured at Different Locations

| Sample | Gurley flow value (s/100 cc) | | | | Average | Deviation |
|---|---|---|---|---|---|---|
| PEI/MCF (100/15)¹ | 2322 | 2315 | 2270 | 2290 | 2299 | 24 |
| PEI/MCF (100/15)² | 1223 | 1118 | 1301 | 1268 | 1228 | 80 |
| PEI/MCF (100/20)¹ | 1393 | 961 | 1398 | 1466 | 1305 | 231 |
| PEI/MCF (100/20)² | 812 | 1154 | 839 | 1187 | 998 | 200 |

*100/15 is the weight ratio of PEI to MCF in casting solutions
¹prepared from 1^{st} half of the polymer solution
²prepared from 2^{nd} half of the polymer solution

### Impact of Porous Silica Structure on Permeability

Another series of porous silica-filled PEI samples was cast using MSU-F, a commercially available porous silica foam from Sigma Aldrich that has a higher density but similar cell structure as compared to MCF. The Gurley flow through these substrates was measured to understand the influence of particle cell structure on their permeability. Properties of MSU-F filled PEI substrates are summarized in Table 4. It was observed that Gurley flow values greatly decrease corresponding as the MSU-F content increases, suggesting that highly permeable PEI substrates can be obtained using casting solutions containing various types of porous silica particles.

TABLE 4
Properties of MSU-F filled PEI Substrates

| | MSU-F | MSU-F | | |
|---|---|---|---|---|
| | Content | Content | Thickness | Gurley Flow |
| Sample | (wt. %) | (vol. %) | (μm) | (s/100 cc) |
| PEI | 0 | 0 | 20.8 | 26,849 |
| PEI/MSU-F (100/5) ¹ | 4.13 | 17.8 | 30.0 | 10,000 |
| PEI/MSU-F (100/5) ² | 3.91 | 17.0 | 19.8 | 12,235 |
| PEI/MSU-F (100/10) ¹ | 7.26 | 28.3 | 30.0 | 5,849 |
| PEI/MSU-F (100/10) ² | 7.29 | 28.4 | 17.5 | 3,434 |

* 100/5 is the weight ratio of PEI to MSU-F in casting solutions
¹ prepared from 1^{st} half of the polymer solution
² prepared from 2^{nd} half of the polymer solution

### Thermal Stability

The thermal stability of PEI substrates was evaluated using the ASTM D 1204-08 method. Briefly, PEI substrates were cut into 10 cm (cast direction) by 5 cm (transverse direction) rectangular coupons. These coupons were pre-conditioned at 23° C. and 50% relative humidity for 24 hours, and then placed on top of a steel plate. The samples were gently covered by steel mesh, and the steel mesh and the steel plate were fastened with paper clips and stored in a conventional oven at a pre-set temperature (e.g., 100 to 200° C.) for 1 hour. Next, these coupons were carefully removed from the oven and reconditioned at 23° C. and 50% relative humidity for at least 1 hour before measuring their length and width. The linear dimensional change was calculated as follows:

$$Δ l = \frac{{L}_{f} - {L}_{o}}{{L}_{o}} \qquad Equation 3$$

where Lₒ and L_{f} are the sample dimensions before and after thermal treatment, respectively.

The thermal stability of silica filled PEI substrates was characterized by measuring dimensional change after heating at certain temperature for 1 hour. Table 5 records the changes observed for exemplary samples.

TABLE 5
Thermal shrinkage of PEI Substrates Having
Various Amounts of Porous Silica Particles

| | Thermal Shrinkage | | | |
|---|---|---|---|---|
| Polymeric Porous | 100° C., | 150° C., | 200° C., | 220° C., |
| Substrate | 1 h | 1 h | 1 h | 1 h |
| PEI | No change | No change | <2% | <2% |
| PEI/MCF (100/7) | No change | No change | <2% | <2% |
| PEI/MCF (100/10) | No change | No change | <2% | <2% |

* 100/7 is the weight ratio of PEI to MCF in the casting solution

What is claimed:

1. A polymeric porous substrate, comprising:
(a) at least one polymer that, when formed into a porous substrate in the absence of porous particles, generates a skin in the substrate; and
(b) a plurality of porous particles.

2. The polymeric porous substrate of claim 1 wherein the at least one polymer when formed into a porous substrate in the absence of porous particles generates a skin in the substrate such that the substrate has a Gurley flow value of greater than 10,000 s/100 cc.

3. The polymeric porous substrate of claim 1 wherein the at least one polymer is soluble in a first solvent, not soluble in a second solvent, where the first and second solvents are miscible in one another.

4. The polymeric porous substrate of claim 1 wherein the at least one polymer comprises a polyimide.

5. The polymeric porous substrate of claim 4 wherein the polyimide comprises a polyetherimide.

6. The polymeric porous substrate of claim 1 wherein the porous particles comprise porous silica.

7. The polymeric porous substrate of claim 1 wherein the porous particles have an average pore diameter of less than 250 nm.

8. The polymeric porous substrate of claim 1 wherein the porous particles have an average pore diameter of less than 50 nm.

9. The polymeric porous substrate of claim 1 wherein the porous particles have an average particle diameter of less than 10 microns.

10. The polymeric porous substrate of claim 1 wherein at least a portion of the porous particles comprise a mesoporous cellular foam.

11. The polymeric porous substrate of claim 1 having a Gurley flow of less than 1500 s/100 cc.

12. A battery separator comprising the polymeric porous substrate of claim 1.

13. A battery separator, comprising:
a polymeric porous substrate formed from
(a) at least one polymer that, when formed into a porous substrate in the absence of porous particles, generates a skin in the substrate such that the substrate has a Gurley flow of greater than 10,000 s/cc; and
(b) a plurality of porous particles,
such that the battery separator has a Gurley flow of less than 1500 s/100 cc.

14. The battery separator of claim 13 wherein the polymeric porous substrate includes porous particles in an amount of from 0.1% to 60% by volume of the separator as calculated by Equation 2.

15. The battery separator of claim 13 wherein the silica is a mesoporous cellular foam.

16. The battery separator of claim 13 wherein the at least one polymer comprises from 40% to 99.9% by volume of the separator as calculated by Equation 2.

17. The battery separator of claim 13 wherein the at least one polymer comprises a polyimide.

18. The battery separator of claim 17 wherein the polyimide comprises a polyetherimide.

19. A battery comprising the battery separator of claim 13.

20. An automotive vehicle comprising the battery of claim 19.
